(19) United States
(12) Patent Application Publication
(10) Pub. No.: US 2021/0188514 A1
(43) Pub. Date: Jun. 24, 2021

(54) RECYCLABLE FLEXIBLE PACKAGE WITH VALVE FOR OXYGEN SENSITIVE PRODUCTS AND METHODS OF MAKING THE SAME

(71) Applicant: Fres-co System USA, Inc., Telford, PA (US)

(72) Inventor: Jeffrey Scott Beer, Coopersburg, PA (US)

(21) Appl. No.: 17/109,625

(22) Filed: Dec. 2, 2020

Related U.S. Application Data
(60) Provisional application No. 62/951,319, filed on Dec. 20, 2019.

(51) Int. Cl. B65D 77/22; B65D 65/40; B32B 1/00; B32B 27/32; B32B 27/30; B32B 27/08; B32B 7/12; B32B 7/06; B32B 37/12

(52) U.S. Cl. CPC B65D 77/225; B65D 65/40; B32B 1/00; B32B 27/32; B32B 27/306; B32B 27/08; B32B 2439/70; B32B 7/06; B32B 37/12; B32B 2439/46; B32B 2255/205; B32B 2255/10; B32B 7/12

(57) ABSTRACT

Disclosed is a recyclable flexible package and method of making it. The flexible package includes a hollow body defining an interior chamber for holding a product. The body is formed of a laminated film resistant to the passage of oxygen therethrough and is formed of at least one layer of a first type of thermoplastic material. A degassing valve is mounted on the body and is formed of the first type of thermoplastic material. The first type of thermoplastic material of the body and the valve constitute at least 95% by weight of the package, whereupon the package is suitable for recycling without requiring separation of the materials thereof.

### CROSS-REFERENCE TO RELATED APPLICATIONS

This utility application claims the benefit under 35 U.S.C. § 119(e) of Provisional Application Ser. No. 62/951,319 filed on Dec. 20, 2019, entitled Recyclable Flexible Package with Valve for Oxygen Sensitive Products and Methods of Making the Same. The entire disclosure of the provisional application is incorporated by reference herein.

### BACKGROUND OF THE INVENTION

### Field of Invention

This invention relates generally to flexible packages, and more particularly to flexible packages with valves for oxygen sensitive products which can be recycled without having to separate the components making up the packages and methods for making such packages.

### Description of Related Art

Flexible packages formed of sheet materials have been used for many years and have wide acceptance for holding various products, e.g., roasted coffee and other foodstuffs. Such packages are typically constructed so that they form a high barrier to oxygen to protect the contents of such packages from the ravages of oxygen. For example, high barrier packages for products, such as coffee, are typically composed of layers of dissimilar materials such as a combination of polyester, aluminum foil or a vacuum deposited aluminum coating, and polyethylene. Moreover, such packages commonly include a one-way degassing valve to enable gases produced by the coffee within the bag from exiting the bag, through the valve, while preventing oxygen from entering the bag through the valve. While his type of package construction performs very well for coffee preservation it leaves much to be desired from the standpoint of ecology. In this regard, such multilayer mixed plastic and metal composition flexible packages are currently unable to be recycled economically because the individual components making up the packages cannot be separated from one another.

Accordingly, a need exists for a high oxygen barrier flexible package with a valve which can be readily recycled. The subject invention addresses that need by providing a flexible package having a degassing valve which is comprised of substantially one thermoplastic material. This allows for easier recycling of the package since there is no need to separate its individual layers and components.

Thus, a need exists for a flexible package laminated film exhibiting a higher oxygen barrier value than the sum of the barrier values of its various component layers. The subject invention addresses that need.

### SUMMARY OF THE INVENTION

One aspect of this invention is a recyclable flexible package configured to be located within an ambient atmosphere. The recyclable flexible package comprises an engagement enhancing liquid, a valve, and a hollow body. The valve is configured to be normally in a closed state, but openable to an open state. The valve consists essentially of a first type of thermoplastic material and comprises a movable valve member and a hollow housing including a portion forming a valve seat. The movable valve member is in engagement with the valve seat when the valve is in the closed state. The engagement liquid is interposed between the movable valve member and the valve seat to assist in the engagement of the movable valve with the valve seat. The hollow body is resistant to atmospheric oxygen transmission through it and is formed of a laminated film of flexible material defining an interior chamber configured for holding a product therein. The valve is mounted on the hollow body interposed between the hollow interior and the ambient atmosphere and configured to isolate the hollow interior from the ambient atmosphere when the valve is in the closed state and to enable a gas within the interior chamber to exit through the valve to the ambient atmosphere when the valve is in the open state. The laminated film comprises at least one layer of the first type of thermoplastic material. The first type of thermoplastic material constitutes at least 95% by weight of the recyclable flexible package, whereupon the recyclable flexible package is suitable for recycling without requiring separation of the materials thereof.

In accordance with one preferred aspect of the recyclable package of this invention the first material is polypropylene.

In accordance with another preferred aspect of the recyclable package of this invention the laminated film comprises a first layer of oriented polypropylene.

In accordance with another preferred aspect of the recyclable package of this invention the laminated film comprises a layer of non-oriented polypropylene.

In accordance with another preferred aspect of the recyclable package of this invention the laminated film additionally comprises a layer of polyvinyl alcohol.

In accordance with another preferred aspect of the recyclable package of this invention the laminated film additionally comprises a layer of polyester-urethane adhesive.

In accordance with another preferred aspect of the recyclable package of this invention the laminated film additionally comprises a second layer of oriented polypropylene.

In accordance with another preferred aspect of the recyclable package of this invention the laminated film additionally comprises a second layer of polyester-urethane adhesive.

In accordance with another preferred aspect of the recyclable package of this invention the laminated film additionally comprises a vacuum deposited aluminum coating.

In accordance with another preferred aspect of the recyclable package of this invention the polyvinyl alcohol layer is disposed over the first layer of oriented polypropylene, the polyester-urethane-adhesive layer is disposed over the polyvinyl alcohol layer, the second layer of oriented polypropylene is disposed over the polyester-urethane-adhesive layer, the second layer of polyester-urethane adhesive is disposed over the second layer of oriented polypropylene, and the layer of non-oriented polypropylene is disposed over the second layer of polyester-urethane adhesive.

In accordance with another preferred aspect of the recyclable package of this invention the first layer of oriented polypropylene is approximately 18-microns thick, the polyvinyl alcohol layer is approximately 0.5 microns thick, the polyester-urethane-adhesive layer is approximately 1.9 microns thick, the second layer of oriented polypropylene is approximately 18-microns thick, the second layer of polyester-urethane adhesive is approximately 1.9 microns thick, and the layer of non-oriented polypropylene is approximately 76 microns thick.

In accordance with another preferred aspect of the recyclable package of this invention the recyclable flexible package additionally comprises a layer of printing ink interposed between the polyvinyl alcohol layer and the layer of polyester-urethane-adhesive.

In accordance with another preferred aspect of the recyclable package of this invention the recyclable flexible package additionally comprises a vacuum deposited aluminum coating interposed between the second layer of oriented polypropylene and the second layer of polyester-urethane adhesive.

In accordance with another preferred aspect of the recyclable package of this invention the vacuum deposited aluminum coating is approximately 1 micron thick.

In accordance with another preferred aspect of the recyclable package of this invention the recyclable flexible package additionally comprises a layer of a peelable seal material on a portion of the laminated film. The portion of the laminated film forms an inner surface of the hollow body and also forms a mouth of the flexible package.

In accordance with another preferred aspect of the recyclable package of this invention the layer of peelable seal is approximately 5 microns thick.

In accordance with another preferred aspect of the recyclable package of this invention the recyclable flexible package additionally comprises a filter.

In accordance with another preferred aspect of the recyclable package of this invention the portion of the valve forming the valve seat comprises a base, and the movable valve member comprises a flexible septum.

In accordance with another preferred aspect of the recyclable package of this invention the hollow housing comprises a cap.

In accordance with another preferred aspect of the recyclable package of this invention the engagement liquid comprises polydimethylsiloxane.

Another aspect of this invention is a method of making a recyclable flexible package. That method entails forming a hollow body resistant to atmospheric oxygen transmission therethrough of a laminated flexible film defining an interior chamber configured for holding a product therein. The laminated film comprises a layer of oriented polypropylene material, a layer of non-oriented polypropylene material, a layer of polyvinyl alcohol material, and a layer of polyester-urethane adhesive material. A valve is mounted on the hollow body so that the valve is interposed between the hollow interior and ambient atmosphere. The valve comprises components formed of polypropylene material and an engagement liquid. The polypropylene material of the body and the valve constitutes at least 95% by weight of the recyclable flexible package, whereupon the recyclable flexible package is suitable for recycling without requiring separation of the materials thereof.

In accordance with one preferred aspect of the method of this invention, the laminated film additionally comprises a second layer of oriented polypropylene material and a second layer of polyester-urethane adhesive material.

In accordance with another preferred aspect of the method of this invention, the polyvinyl alcohol material layer is disposed over the oriented polypropylene material layer, the polyester-urethane-adhesive material layer is disposed over the polyvinyl alcohol material layer, the second layer of oriented polypropylene material is disposed over the polyester-urethane-adhesive material layer, the second layer of polyester-urethane adhesive material is disposed over the second layer of oriented polypropylene material, and the layer of non-oriented polypropylene material is disposed over the second layer of polyester-urethane adhesive material.

In accordance with another preferred aspect of the method of this invention, a vacuum deposited aluminum coating is interposed between the second layer of oriented polypropylene material and the second layer of polyester-urethane adhesive material.

In accordance with another preferred aspect of the method of this invention, a layer of printing ink is interposed between the polyvinyl alcohol material layer and the polyester-urethane-adhesive material layer.

In accordance with another preferred aspect of the method of this invention, a layer of a peelable seal material is provided on a portion of the laminated film. The portion of the laminated film forms an inner surface of the hollow body and also forms a mouth of the flexible package.

In accordance with another preferred aspect of the method of this invention, the layer of oriented polypropylene material is approximately 18-microns thick, the polyvinyl alcohol material layer is approximately 0.5 microns thick, the polyester-urethane-adhesive material layer is approximately 1.9 microns thick, the second layer of oriented polypropylene material is approximately 18-microns thick, the second layer of polyester-urethane adhesive material is approximately 1.9 microns thick, and the layer of non-oriented polypropylene material is approximately 76 microns thick.

In accordance with another preferred aspect of the method of this invention, a vacuum deposited aluminum coating is interposed between the second layer of oriented polypropylene material and the second layer of polyester-urethane adhesive material. The vacuum deposited aluminum coating is approximately 1 micron thick.

In accordance with another preferred aspect of the method of this invention, a layer of a peelable seal material is provided on a portion of the laminated film. The portion of the laminated film forms an inner surface of the hollow body and also forms a mouth of the flexible package. The layer of peelable seal material is approximately 5 microns thick.

In accordance with another preferred aspect of the method of this invention, the oriented polypropylene material layer is coated with polyvinyl alcohol to form the polyvinyl alcohol material layer. Then the layer of polyester-urethane adhesive is applied thereover to form the polyester-urethane adhesive layer, after which additional oriented polypropylene material is applied to the polyester-urethane adhesive layer by the application of heat and pressure to form the second oriented polypropylene material layer, after which additional polyester-urethane adhesive material is applied to an exposed surface of the second oriented polypropylene material layer to form the second polyester-urethane adhesive material layer, after which non-oriented polypropylene material is applied to the second polyester-urethane adhesive material layer to form the non-oriented polypropylene material layer and complete the formation of the laminated film.

In accordance with another preferred aspect of the method of this invention, the method additionally comprises additionally winding the laminated film onto a roll or coil.

In accordance with another preferred aspect of the method of this invention, the method additionally comprises allowing the laminated film on the roll or coil to cure for a period of time, and then converting it into the recyclable flexible package.

In accordance with another preferred aspect of the method of this invention, the method additionally comprises applying printing ink over the polyvinyl alcohol material layer before the layer of polyester-urethane adhesive is applied thereover.

In accordance with another preferred aspect of the method of this invention, the method additionally comprises applying a vacuum deposited aluminum coating between the second layer of oriented polypropylene material and the second layer of polyester-urethane adhesive material.

### DESCRIPTION OF THE DRAWING

The invention will be described in conjunction with the following drawings in which like reference numerals designate like elements and wherein:

FIG. 1 is an isometric view of one exemplary recyclable flexible package constructed in accordance with this invention;

FIG. 2 is a cross-section view, taken along line 2-2 and showing the construction of the degassing valve forming a portion of the recyclable package of FIG. 2;

FIG. 3 is a highly enlarged, but not to scale, cross sectional view taken along line 3-3 of FIG. 1 showing the construction of the laminated film making up the body of the recyclable flexible package shown in FIG. 1;

FIG. 4 is a highly enlarged, but not to scale, cross sectional view taken along line 4-4 of FIG. 1 showing the peelable mouth of the recyclable flexible package shown in FIG. 1; and

FIG. 5 is a cross-sectional view, similar to FIG. 3, but showing an alternative embodiment of a laminated film making up the body of the recyclable flexible package shown in FIG. 1;

### DETAILED DESCRIPTION OF THE PREFERRED EMBODIMENT

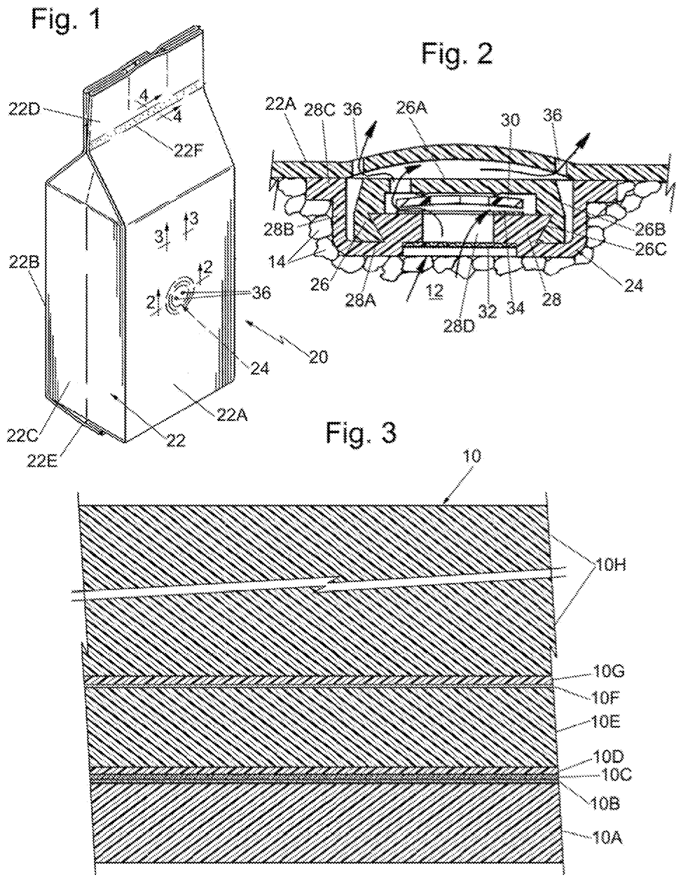

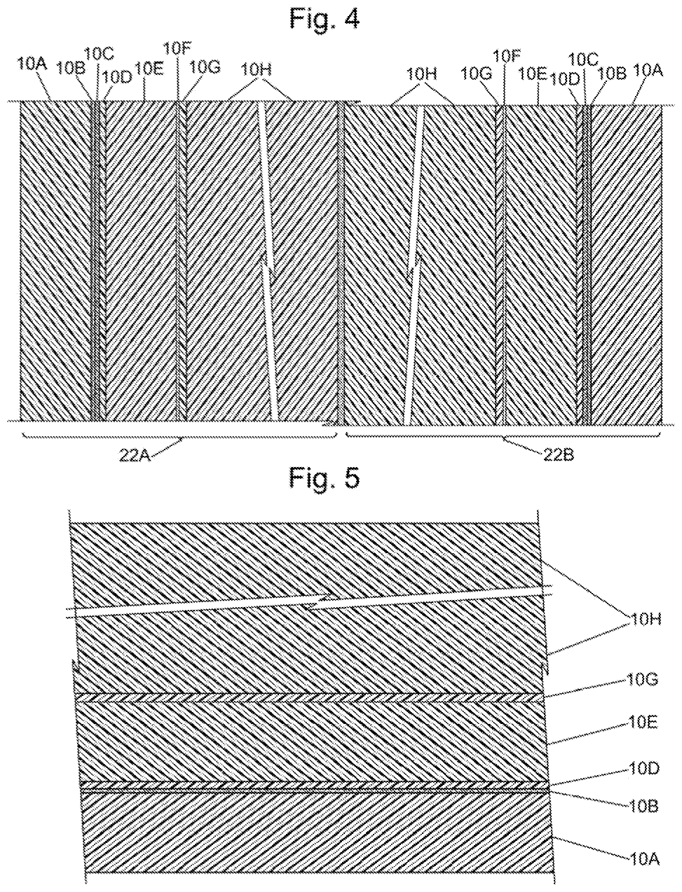

Referring now to the various figures of the drawing wherein like reference characters refer to like parts, there is shown in FIG. 1 one exemplary embodiment of a recyclable flexible package 20 constructed in accordance with this invention. The flexible package 20 is configured to include an interior chamber for holding an oxygen sensitive product, e.g., coffee beans, ground coffee, etc., to preserve that product by blocking atmospheric oxygen transmission through the walls of the package. The exemplary package 20 is in the form of a gusseted bag 22 formed of a laminated film 10 (FIGS. 3 and 4) which forms a barrier to the passage of oxygen from the ambient atmosphere into the interior chamber of the bag. A pressure-equalizing, one-way degassing valve 24 is mounted on the bag's front wall to enable gases produced by the coffee within the bag to exit the bag through the valve 24.

It should be noted at this point that while the bag 22 is shown in the form of a gusseted bag, it may take other constructions and still be within the scope of this invention. By way of example, but not limitation, the bag portion of a package constructed in accordance with this invention may be in the form of a so-called “pillow bag”, a “stand-up pouch” or any other type or style of flexible package. What is important is the thermoplastic material making up the package being of the same type so that the package needn't be separated for recycling. To that end, as will be described in detail later the bag 22 is formed of a laminated film material which by weight is essentially one type of thermoplastic material, e.g., polyethylene, with the valve being formed of the same type of thermoplastic material.

As mentioned earlier, the exemplary gusseted bag 22 is formed of a flexible laminated film 10. In particular it basically comprises a front wall or panel 22A, a rear wall or panel 22B, a pair of identical opposed gusseted side walls or panels 22C, a top end portion 22D, and a bottom end portion 22E. The top end portion of the bag terminates in a top marginal edge, while the bottom end portion terminates in a bottom marginal edge. The degassing valve 24 is mounted in the front panel 22A, although it can be located in the rear panel as well, and is in communication with the interior of the bag, which is in the form of a hollow chamber 12 (FIG. 2) for holding the coffee 14 therein. The valve 24 enables gasses which may be produced by the material(s) (e.g., coffee 14) contained within the chamber 12 after the bag is hermetically sealed to vent to the ambient air, without air gaining ingress to the bag's chamber.

In the exemplary embodiment of the package 20 the front panel 22A, rear panel 22B, and the two gusseted sides 22C of the bag are all integral portions of a single sheet or web of the flexible film 10 which has been folded and seamed to form a tubular body. The package has a peelable mouth formed by a line 22F of conventional peelable seal material located on portions of the inner surface of the walls of the bag adjacent, e.g., slightly below, its top marginal edge and extending across the width of the front and rear panels and the interposed gusseted sides as best seen in FIGS. 1 and 4. The peelable seal line 22F enables the walls of the bag to be readily peeled apart to open the mouth to provide access to the product held within the interior of the bag. The package 20 is arranged to be initially hermetically sealed closed along the peelable seal line 22F after it has been filled and vacuumized.

The lower or bottom end of the bag 22 is sealed closed along a transverse, permanent seam line (not shown) closely adjacent the bottom edge 36. The permanent seam line is formed using any conventional sealing technique. When the bag 20 is filled, vacuumized, and sealed its particulate contents, e.g., coffee 14, will be kept isolated from the ambient air by the material barrier properties of the laminated film making up the bag 22.

The degassing valve 24 is best seen in FIG. 2 and is constructed similar to the valve of U.S. Pat. No. 5,893,461, whose disclosure is specifically incorporated herein, and basically comprises a cap 26, a base 28, a movable valve member or septum 30, and a filter member 32. The cap and base when connected together form the housing of the valve. The septum 30 is in the form of a flexible disk which is located within the housing. The cap 26 is a generally cylindrical member having a planar circular top wall 26A and a circular slightly conical side wall 26B terminating at its bottom in an under-cut annular groove 26C. The base member 28 is a generally cup-shaped member having a planar circular bottom wall 28A and a circular sidewall 28B terminating at its top in an annular flange 28C. The bottom wall 28A includes a central opening or hole 28D having an annular flange extending thereabout and projecting up from the interior surface of the bottom wall 28A. The annular flange is under-cut on its exterior surface to be received in and mate with, e.g., snap-fit in, the under-cut groove 26C in the cap 26 to connect the cap to the base and thereby complete the valve's housing.

The entrance to the central opening or hole 28D in the base 28 is located at the bottom of the bottom wall 28A and is enlarged to form a ledge on which the filter member 32 is disposed and secured, e.g., glued. The top surface of the base surrounding the central opening or hole 28D is planar and forms the valve seat 28E of the valve. A thin layer of polydimethylsiloxane (silicone oil) 34 is interposed between the disk 30 and the valve seat 28E. As is known, the presence of the oil 34 interposed between the septum and the valve seat serves an engagement enhancing liquid which forms an elastic bond to enhance the engagement of the septum on the valve seat when the valve is in its normally closed state.

The flange 28C of the base serves as the means to secure the valve 24 to the front panel or wall 22A of the package 20. To that end, the valve's flange 28C is welded or heat sealed about its entire top surface to the inner surface of the front wall 22A. A pair of small apertures or holes 36 is provided in the front wall of the bag within the bounds of the seal line extending around the flange 26C. Those apertures are in fluid communication with the interior of the valve located above the septum 30. The valve is configured to be in a normally closed state, whereupon the underside of the septum 30 contiguous with its outer periphery is in engagement with the valve seat 28E via the interposed oil 34 to thereby close off the opening or hole 28D and thus isolate the interior of the bag from the ambient atmosphere.

As will be appreciated by those skilled in the art, when the pressure in the interior chamber 12 of the bag is higher than the pressure of the ambient air surrounding the package, as may occur when the coffee within the package degasses, the higher internal pressure will break the elastic bond between the valve seat, the oil 34, and the septum 30, allowing the gas within the package to escape in the direction of arrows shown in FIG. 2 out of the valve and through the holes 36 in the front panel of the bag.

In accordance with a preferred embodiment of this invention the cap 26 and base 28 are injection molded of polypropylene, the disk 30 is stamped from a sheet of polypropylene and the filter member 32 comprises a circular disk of non-woven polypropylene. As such one exemplary valve 24 constructed in accordance with this invention is composed of approximately 1,000 milligrams of polypropylene and 4 milligrams of silicone oil, so that the valve constitutes approximately 99.6% polypropylene by weight.

Turning now to FIG. 3 the details of one exemplary laminated film 10 constructed in accordance with this invention to produce the bag 22 will now be described. To that end, the laminated film 10 is constructed and produced as follows. A film layer 10A of oriented polypropylene having a thickness of approximately 18 microns is first coated with a layer 10B of polyvinyl alcohol having a thickness of approximately 0.5 microns. Next, an optional layer 10C of printing ink(s) is/are applied over the polyvinyl alcohol to decorate the package. Next, a layer 10D of polyester-urethane adhesive having a thickness of approximately 1.9 microns is applied over the printing ink layer, if that layer is used. If the laminated film does not include a layer of printing ink(s), the polyester-urethane adhesive layer 10D is applied over the polyvinyl alcohol layer 10B. Next a second layer 10E of oriented polypropylene having a thickness of approximately 18 microns is applied over the polyester-urethane adhesive layer 10D, by application of heat and pressure. Next, an optional coating 10F of aluminum is vacuum deposited on the second layer 10E of oriented polypropylene. The aluminum coating has a thickness of approximately 1 micron or less and is used to provide a light barrier, oxygen barrier, moisture barrier and static dissipation for the laminated film. Next a second layer 10G of polyester-urethane adhesive having a thickness of approximately 1.9 microns is applied to the exposed side of the aluminum coating 10F, if such a coating is used. If, the laminated film doesn't include the optional aluminum coating, the second layer 10G of polyester-urethane adhesive is applied to the second layer 10E of oriented polypropylene. A layer 10H of non-oriented polypropylene having a thickness of approximately 76 microns is applied over the second layer 10G of polyester-urethane adhesive to complete the laminated film, which is then wound onto a roll or coil.

The coil of laminated film can then be allowed to cure for 5-7 days and then converted into the exemplary gusseted package 20 or any other type of flexible package, with the non-oriented polypropylene of layer 10H forming the inner surface of the bag 22. As mentioned above, the inside of the bag may include a peelable seal material at its mouth to enable the mouth to be peeled open. The peelable seal material is in the form of a coating applied in a line 22F to the area of the laminated film which will form the mouth of the bag. The peelable coating can be made of a variety of known peelable coating materials, and is only applied to about 10% of the exposed side of the oriented polypropylene layer, is approximately 5 microns thick in the coated area and can be applied to the non-oriented polypropylene layer 10H just prior to the formation of the bag, or during the formation of the bag.

In FIG. 5 there is shown an alternative laminated film 10′ constructed in accordance with this invention. The film 10′ is constructed similarly to the film 10, but does not include the optional printing ink layer 10C and the optional aluminum coating layer 10F.

Flexible packages constructed in accordance with this invention will constitute at least 95% by weight of the thermoplastic, e.g., polypropylene, so that those packages can be recycled without necessitating separating their various plies or layers of the bags or separating the valves from the bags. Moreover, the flexible packages of this invention will still provide excellent resistant to the passage of oxygen therethrough. In this regard, barrier to oxygen of the composite material making up the laminated film of the package this invention has been measured in a laboratory per ASTM D3985 at 0.02 cc/(100 square inches-24 hours) at 23 degrees C. and 0% RH.

It must be pointed out at this juncture that the exemplary laminated films as described above are mere some examples of laminated films that can be used to make recyclable flexible packages in accordance with this invention, Thus, such films may make use of more or less layers or plies of various types of materials so long as the laminated film is composed of at least 95% by weight of a single type of thermoplastic material. Moreover, any type or construction of a degassing valve can be used, and need not be constructed like the exemplary valve 24 described above so long as the valve is formed of the same type of thermoplastic as that used in the laminated film and whereby the thermoplastic material constitutes at least 95% by weight of the recyclable flexible package.

While the invention has been described in detail and with reference to specific examples thereof, it will be apparent to one skilled in the art that various changes and modifications can be made therein without departing from the spirit and scope thereof.

I claim:

1. A recyclable flexible package configured to be located within an ambient atmosphere, said recyclable flexible package comprising:
an engagement enhancing liquid;
a valve configured to be normally in a closed state, but openable to an open state, said valve consisting essentially of a first type of thermoplastic material and comprising a movable valve member and a hollow housing including a portion forming a valve seat, said movable valve member being in engagement with said valve seat when said valve is in said closed state, said engagement liquid being interposed between said movable valve member and said valve seat to assist in said engagement of said movable valve with said valve seat; and
a hollow body resistant to atmospheric oxygen transmission therethrough and formed of a laminated flexible film defining an interior chamber configured for holding a product therein, said valve being mounted on said hollow body interposed between said hollow interior and the ambient atmosphere and configured to isolate said hollow interior from the ambient atmosphere when said valve is in said closed state and to enable a gas within said interior chamber to exit through said valve to the ambient atmosphere when said valve is in said open state, said laminated flexible film comprising at least one layer of said first type of thermoplastic material, said first type of thermoplastic material constituting at least 95% by weight of said recyclable flexible package, whereupon said recyclable flexible package is suitable for recycling without requiring separation of the materials thereof.

2. The recyclable flexible package of claim 1, wherein said first material is polypropylene.

3. The recyclable flexible package of claim 2, wherein said laminated film comprises a first layer of oriented polypropylene.

4. The recyclable flexible package of claim 3, wherein said laminated film comprises a layer of non-oriented polypropylene.

5. The recyclable flexible package of claim 4, wherein said laminated film additionally comprises a layer of polyvinyl alcohol.

6. The recyclable flexible package of claim 5, wherein said laminated film additionally comprises a layer of polyester-urethane adhesive.

7. The recyclable flexible package of claim 6, wherein said laminated film additionally comprises a second layer of oriented polypropylene.

8. The recyclable flexible package of claim 7, wherein said laminated film additionally comprises a second layer of polyester-urethane adhesive.

9. The recyclable flexible package of claim 7, wherein said laminated film additionally comprises a vacuum deposited aluminum coating.

10. The recyclable flexible package of claim 8, wherein said polyvinyl alcohol layer is disposed over said layer of oriented polypropylene, wherein said polyester-urethane-adhesive layer is disposed over said polyvinyl alcohol layer, wherein said second layer of oriented polypropylene is disposed over said polyester-urethane-adhesive layer, wherein said second layer of polyester-urethane adhesive is disposed over said second layer of oriented polypropylene, and wherein said layer of non-oriented polypropylene is disposed over said second layer of polyester-urethane adhesive.

11. The recyclable flexible package of claim 10, wherein said layer of oriented polypropylene is approximately 18-microns thick, wherein said polyvinyl alcohol layer is approximately 0.5 microns thick, wherein said polyester-urethane-adhesive layer is approximately 1.9 microns thick, wherein said second layer of oriented polypropylene is approximately 18-microns thick, wherein said second layer of polyester-urethane adhesive is approximately 1.9 microns thick, and wherein said layer of non-oriented polypropylene is approximately 76 microns thick.

12. The recyclable flexible package of claim 11, additionally comprising a layer of printing ink interposed between said polyvinyl alcohol layer and said layer of polyester-urethane-adhesive.

13. The recyclable flexible package of claim 11, additionally comprising a vacuum deposited aluminum coating interposed between said second layer of oriented polypropylene and said second layer of polyester-urethane adhesive.

14. The recyclable flexible package of claim 13, wherein said vacuum deposited aluminum coating is approximately 1 micron thick.

15. The recyclable flexible package of claim 12, additionally comprising a vacuum deposited aluminum coating interposed between said second layer of oriented polypropylene and said second layer of polyester-urethane adhesive.

16. The recyclable flexible package of claim 15, wherein said vacuum deposited aluminum coating is approximately 1 micron thick.

17. The recyclable flexible package of claim 1, additionally comprising a layer of a peelable seal material on a portion of said laminated film, said portion of said laminated film forming an inner surface of said hollow body and also forming a mouth of said flexible package.

18. The recyclable flexible package of claim 17, wherein said layer of peelable seal material is approximately 5 microns thick.

19. The recyclable flexible package of claim 11, additionally comprising a layer of a peelable seal material on a portion of said laminated film, said portion of said laminated film forming an inner surface of said hollow body and also forming a mouth of said flexible package.

20. The recyclable flexible package of claim 19, wherein said layer of peelable seal material is approximately 5 microns thick.

21. The recyclable flexible package of claim 1, wherein said valve additionally comprises a filter.

22. The recyclable flexible package of claim 21, wherein said portion of said valve forming said valve seat comprises a base, wherein said movable valve member comprises a flexible septum.

23. The recyclable flexible package of claim 21, wherein said hollow housing comprises a cap.

24. The recyclable flexible package of claim 22, wherein said hollow housing comprises a cap.

25. The recyclable flexible package of claim 1, wherein said engagement liquid comprises polydimethylsiloxane.

26. A method of making a recyclable flexible package comprising:
forming a hollow body resistant to atmospheric oxygen transmission therethrough of a laminated flexible film defining an interior chamber configured for holding a product therein, said laminated film comprising a layer of oriented polypropylene material, a layer of non-oriented polypropylene material, a layer of polyvinyl alcohol material, and a layer of polyester-urethane adhesive material; and
mounting a valve on said hollow body, whereupon said valve is interposed between said hollow interior and ambient atmosphere, said valve comprising components formed of polypropylene material and an engagement liquid, said polypropylene material of said body and said valve constituting at least 95% by weight of said recyclable flexible package, whereupon said recyclable flexible package is suitable for recycling without requiring separation of the materials thereof.

27. The method of claim 26, wherein said laminated film additionally comprises a second layer of oriented polypropylene material and a second layer of polyester-urethane adhesive material.

28. The method of claim 27, wherein said polyvinyl alcohol material layer is disposed over said oriented polypropylene material layer, wherein said polyester-urethane-adhesive material layer is disposed over said polyvinyl alcohol material layer, wherein said second layer of oriented polypropylene material is disposed over said polyester-urethane-adhesive material layer, wherein said second layer of polyester-urethane adhesive material is disposed over said second layer of oriented polypropylene material, and wherein said layer of non-oriented polypropylene material is disposed over said second layer of polyester-urethane adhesive material.

29. The method of claim 28, additionally comprising a vacuum deposited aluminum coating interposed between said second layer of oriented polypropylene material and said second layer of polyester-urethane adhesive material.

30. The method of claim 29, additionally comprising a layer of printing ink interposed between said polyvinyl alcohol material layer and said polyester-urethane-adhesive material layer.

31. The method of claim 28, additionally comprising a layer of a peelable seal material on a portion of said laminated film, said portion of said laminated film forming an inner surface of said hollow body and also forming a mouth of said flexible package.

32. The method of claim 28, wherein said layer of oriented polypropylene material is approximately 18-microns thick, wherein said polyvinyl alcohol material layer is approximately 0.5 microns thick, wherein said polyester-urethane-adhesive material layer is approximately 1.9 microns thick, wherein said second layer of oriented polypropylene material is approximately 18-microns thick, wherein said second layer of polyester-urethane adhesive material is approximately 1.9 microns thick, and wherein said layer of non-oriented polypropylene material is approximately 76 microns thick.

33. The method of claim 32, additionally comprising a vacuum deposited aluminum coating interposed between said second layer of oriented polypropylene material and said second layer of polyester-urethane adhesive material, said vacuum deposited aluminum coating being approximately 1 micron thick.

34. The method of claim 32, additionally comprising a layer of a peelable seal material on a portion of said laminated film, said portion of said laminated film forming an inner surface of said hollow body and also forming a mouth of said flexible package, said layer of peelable seal material is approximately 5 microns thick.

35. The method of claim 33, additionally comprising a layer of a peelable seal material on a portion of said laminated film, said portion of said laminated film forming an inner surface of said hollow body and also forming a mouth of said flexible package, said layer of peelable seal material is approximately 5 microns thick.

36. The method of claim 32, wherein said oriented polypropylene material layer is coated with polyvinyl alcohol to form said polyvinyl alcohol material layer, then said layer of polyester-urethane adhesive is applied thereover to form said polyester-urethane adhesive layer, after which additional oriented polypropylene material is applied to said polyester-urethane adhesive layer by the application of heat and pressure to form said second oriented polypropylene material layer, after which additional polyester-urethane adhesive material is applied to an exposed surface of said second oriented polypropylene material layer to form said second polyester-urethane adhesive material layer, after which non-oriented polypropylene material is applied to said second polyester-urethane adhesive material layer to form said non-oriented polypropylene material layer and complete the formation of said laminated film.

37. The method of claim 36, additionally comprising winding said laminated film onto a roll or coil.

38. The method of claim 37, additionally comprising allowing said laminated film on said roll or coil to cure for a period of time, and then converting it into said recyclable flexible package.

39. The method of claim 36, additionally comprising applying printing ink over said polyvinyl alcohol material layer before said layer of polyester-urethane adhesive is applied thereover.

40. The method of claim 36, additionally comprising applying a vacuum deposited aluminum coating between said second layer of oriented polypropylene material and said second layer of polyester-urethane adhesive material.
